(19) United States
(12) Patent Application Publication
(10) Pub. No.: US 2022/0380543 A1
(43) Pub. Date: Dec. 1, 2022

(54) Composition for Forming Polyimide Film for Cover Window, Method for Preparing Same, and Uses Thereof

(71) Applicants: SK Innovation Co., Ltd., Seoul (KR); SK ie technology Co., Ltd., Seoul (KR)

(72) Inventors: Cheol Min Yun, Daejeon (KR); Hye Jin Park, Daejeon (KR)

(21) Appl. No.: 17/748,119

(22) Filed: May 19, 2022

(30) Foreign Application Priority Data
May 20, 2021 (KR) 10-2021-0064918

(51) Int. Cl. C08G 73/10

(52) U.S. Cl. CPC C08G 73/1067

(57) ABSTRACT

One embodiment relates to a composition for forming a polyimide film for a cover window, a method for preparing the same, and uses thereof. According to one embodiment, it is possible to provide a polyimide film for a cover window that has excellent isotropy and scattering resistance, and at the same time is flexible and has excellent bending physical properties, without lowering colorless and transparent optical physical properties. In addition, the polyimide film for a cover window according to an embodiment may be usefully used in various flexible display devices.

### CROSS REFERENCE TO RELATED APPLICATION

The application claims priority to Korean Patent Application No. 10-2021-0064918, filed May 20, 2021, the disclosure of which is hereby incorporated by reference in its entirety.

### BACKGROUND OF THE INVENTION

### Field of the Invention

The present disclosure relates to a composition for forming a polyimide film for a cover window, a method for preparing the same, and uses thereof.

### Description of Related Art

A display device has a cover window for the display device provided on a display panel in order to protect the display panel from scratches or external impact. Recently, a flexible display panel that may be curved or bent flexibly is in the spotlight as a next-generation display, and a polymer material capable of imparting flexibility as a cover window material of the next-generation display is attracting attention. Among them, polyimide (PI), a polymer that is easy to synthesize and has excellent heat resistance and chemical resistance, has been mainly used.

In order to be applied to an outermost window substrate of smart devices, excellent optical physical properties such as transmittance, low refractive index, and phase delay are essential to secure a viewing angle of the display. Furthermore, in order to be applicable to a foldable or flexible display device, mechanical physical properties need to be improved. Therefore, the required performance of a cover window for a display device is gradually being upgraded.

A color of a typical polyimide is brown or yellow, which is mainly caused by a charge transfer complex (CTC) by intra molecular and inter molecular interactions of the polyimide. This lowers the light transmittance of the polyimide film and increases birefringence, resulting in causing a problem of a narrow viewing angle.

To solve this problem, a colorless and transparent polyimide may be prepared by reducing the CTC effect by combining or changing monomers of various structures. However, optical physical properties and mechanical physical properties are in a trade-off relationship with each other, and such an attempt has no choice but to obtain extremely general results of reduced functionality or deteriorated mechanical physical properties even if the optical physical properties of the polyimide are improved. Accordingly, studies to improve the transmittance and color transparency have been continued as long as the heat resistance and mechanical physical properties of the polyimide are not greatly reduced, but there is a limit in satisfying the optical physical properties in terms of refractive index and phase delay.

Therefore, it is necessary to develop a material for a cover window that may replace expensive tempered glass by satisfying both excellent mechanical physical properties and realization of improved optical physical properties without lowering colorless and transparent performance.

### SUMMARY OF THE INVENTION

### Technical Problem

An embodiment is directed to providing a composition for forming a polyimide film for a cover window and a polyimide film for a cover window prepared therefrom, which can satisfy performance required for an advanced cover window.

Specifically, one embodiment provides a polyimide film for a cover window that is colorless and transparent, and can simultaneously implement significantly improved retardation, excellent mechanical physical properties, and excellent heat resistance, and a multilayer structure including the same.

In addition, one embodiment provides a method for preparing a composition for forming a polyimide film for a cover window for realizing the above-described physical properties, and a method for preparing a polyimide film for a cover window.

In addition, one embodiment provides a cover window that may replace tempered glass and a flexible display device including the same, and a new material for a cover window that satisfies excellent optical physical properties and mechanical physical properties and has excellent scattering resistance

### Technical Solution

In one general aspect, a composition for forming a polyimide film for a cover window may include: polyamic acid or polyimide including a structural unit derived from a dianhydride and a structural unit derived from diamine; and a mixed solvent of an amide-based solvent and a hydrocarbon-based solvent, in which, in the composition for forming a polyimide film for a cover window satisfying Relational Expression 1 below, the structural unit derived from the dianhydride may include a structural unit derived from a compound represented by Chemical Formula 1 below, and the structural unit derived from the diamine may include a structural unit derived from a compound represented by Chemical Formula 2 below.

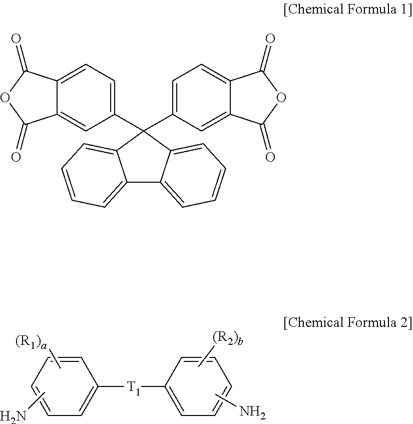

5,000≤V_{PI}≤20,000 [Relational Expression 1]

[in the Chemical Formula 2 above,

R₁ and R₂ may be each independently (C1-C10) alkyl, halo(C1-C10) alkyl, (C6-C12) aryl, halogen, hydroxy, (C1-C10) alkoxy, cyano, thiol, (C1-C10) mercapto, or nitro;

T₁ is selected from the group consisting of a single bond, (C1-C10) alkylene, (C6-C12) arylene, —O—, —C(═O)—, —C(═O)O—, C(═O)NH—, —S—, —SO₂—, and combinations thereof;

a and b are each independently an integer from 0 to 3;

in the Relational Expression 1 above,

V_{PI} is a viscosity of the composition for forming a polyimide film for a cover window when a solid content is 15 wt % based on a total weight of the composition for forming a polyimide film for a cover window, and the viscosity is a viscosity (unit, cp) measured with a Brookfield rotational viscometer using a 52Z spindle at 25° C. based on a torque of 80% for 2 minutes.]

The diamine represented by the Chemical Formula 2 above may be represented by Chemical Formula 3 below.

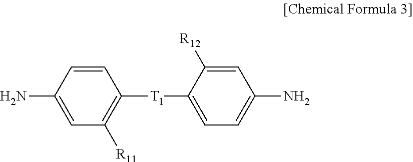

[in the Chemical Formula 3 above,

R₁₁ and R₁₂ are each independently hydrogen or halo (C1-C10) alkyl;

T₁ is a single bond, —O—, or

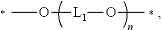

in which n is an integer of 1 to 3;

L₁ is (C1-C10) alkylene or (C6-C12) arylene.]

The amide-based solvent may include dimethylpropionamide.

The hydrocarbon-based solvent may be a cyclic hydrocarbon-based solvent.

The cyclic hydrocarbon-based solvent may be toluene, benzene, cyclohexane, or a combination thereof.

The hydrocarbon-based solvent may be added after polymerization of the polyamic acid or polyimide.

The solid content of the composition for forming a polyimide film for a cover window is included in an amount of 10 to 40 wt % based on the total weight of the composition for forming a polyimide film.

The composition for forming a polyimide film for a cover window may include the amide-based solvent and the hydrocarbon-based solvent in a weight ratio of 8:2 to 5:5.

According to one embodiment, the polyimide film for a cover window may be prepared from the composition for forming a polyimide film for a cover window.

The polyimide film for a cover window may have a thickness of 20 to 500 μm and have an absolute value of retardation Rth of 100 to 300 nm in a thickness direction at a wavelength of 550 nm is 100 to 300 nm.

The polyimide film for the cover window may have a yellow index (YI) of 4 or less according to ASTM E131.

According to another embodiment, a method for preparing a polyimide film for a cover window may include: applying the composition for forming a polyimide film for a cover window to a substrate; and curing the composition for forming a polyimide film for a cover window by drying and heating.

The curing may be performed by drying at 30° C. to 70° C., and then heating at 80° C. to 300° C., and the method for preparing a polyimide film for a cover window may further include, after the applying, leaving the composition at room temperature.

According to still another embodiment, a multilayer structure may include the polyimide film for a cover window provide on one surface of a substrate.

According to further another embodiment, a cover window for a display device may include: the polyimide film; and a coating layer formed on the polyimide film.

The coating layer may be a hard coating layer, an antistatic layer, an anti-fingerprint layer, an antifouling layer, an anti-scratch layer, a low refractive layer, an antireflection layer, an impact absorption layer, or a combination thereof.

According to still further another embodiment, a flexible display device may include the polyimide film.

### Advantageous Effects

According to a composition for forming a polyimide film for a cover window according to an embodiment, it is possible to remarkably reduce an intermolecular packing density during curing by inhibiting an interaction between polyamic acid and a mixed solvent. Accordingly, it is possible to provide a polyimide film for a cover window that may simultaneously implement excellent optical physical properties and excellent mechanical physical properties without lowering colorless and transparent performance. In addition, the polyimide film is flexible and has excellent bending properties, and thus, may be applied to a cover window of a flexible display

Specifically, a composition for forming a polyimide film for a cover windshield according to an embodiment may provide a polyimide film having a remarkably improved retardation while keeping transmittance and mechanical physical properties excellent. Accordingly, by effectively suppressing mura and rainbow phenomena which are problems of visibility when used as a cover window of a display panel, it is possible to increase the reliability of the display panel including the same.

### DESCRIPTION OF THE INVENTION

Hereinafter, one embodiment will be described in detail so that a person of ordinary skill in the art to which the present invention pertains can easily implement the present invention. However, the present invention may be implemented in various different forms and is not limited to embodiments described herein. In addition, embodiments are not intended to limit the scope of protection limited by the claims.

In this case, technical terms and scientific terms used in the present specification have the general meaning understood by those skilled in the art to which the present invention pertains unless otherwise defined, and a description for the known function and configuration unnecessarily obscuring the gist of the present invention will be omitted in the following description.

Throughout the present specification, when a part “includes” a certain component, it may mean that it may further other components, rather than excluding other components, unless otherwise stated.

When an element such as a layer, a film, a thin film, a region, and a plate is “on” or “over” another component in the specification, it can be directly on the other element or intervening elements may be present therebetween, unless otherwise defined herein.

Hereinafter, unless otherwise defined herein, the term “combination thereof” may mean mixing or copolymerization of constituents.

Hereinafter, unless otherwise defined herein, “A and/or B” may mean an aspect including A and B at the same time, and may mean an aspect selected from A and B.

Hereinafter, unless otherwise defined herein, “polymer” refers to a molecule having a relatively high molecular weight, and its structure may include multiple repeats of units derived from molecules of a low molecular weight. In one aspect, the polymer is an alternating copolymer, a block copolymer, a random copolymer, a branched copolymer, a crosslinked copolymer, or a copolymer (e.g., a copolymer including more than one type of monomer) including both. In another aspect, the polymer may be a homopolymer (e.g., a copolymer including one monomer).

Hereinafter, unless otherwise defined herein, “polyamic acid” may refer to a polymer including a structural unit having an amic acid moiety, and “polyimide” may refer to a polymer including a structural unit having an imide moiety.

Hereinafter, unless otherwise defined herein, the polyimide film may be a film including polyimide, and specifically, the polyimide film may be a high-heat resistance film that is prepared by preparing polyamic acid by solution polymerization of a dianhydride compound and a diamine compound or a diisocyanate compound, and then imidizing the polyamic acid by ring closure dehydration at a high temperature.

Hereinafter, unless otherwise defined herein, the term “mura phenomenon” may be interpreted to encompass all distortions caused by light that may be caused at a specific angle. For example, in a display device including a polyimide film, distortion due to light, such as a blackout phenomenon in which a screen appears black, a hot spot phenomenon, or a rainbow phenomenon having iridescent stains, may be mentioned.

Hereinafter, a composition for forming a polyimide film for a cover window according to an embodiment will be described.

The composition (hereinafter, also referred to as composition for forming a polyimide film for a cover window) for forming a polyimide film for a cover window according to an embodiment may provide a polyimide film for a cover window with improved optical physical properties and mechanical physical properties at the same time by changing a solvent condition, and specifically, by applying a non-polar solvent that may not be used as a polymerization solvent of polyamic acid (hereinafter, also referred to as a polyimide precursor) and/or polyimide and has no affinity with polyimide.

Specifically, the composition for forming a polyimide film for a cover window according to an embodiment may include polyamic acid and/or polyimide; a polar solvent; and a non-polar solvent. The polar solvent may be a hydrophilic solvent, and may have affinity with, for example, polyamic acid and/or polyimide, and for example, may be an amide-based solvent. In addition, the non-polar solvent may have little affinity with polyamic acid and/or polyimide, and may be, for example, a hydrocarbon-based solvent.

Although not limited to a particular theory, by using a mixed solvent of an amide-based solvent and a hydrocarbon-based solvent, an intermolecular interaction between polymers and/or an interaction between the polymer and the solvent may be effectively inhibited, and an intermolecular packing density is remarkably lowered, thereby making both the optical and mechanical physical properties excellent.

The composition for forming a polyimide film for a cover window according to an embodiment may exhibit intermolecular behavior and interaction different than simply adding a mixed solution in a step of polymerizing polyamic acid. For example, when the hydrocarbon-based solvent is included in the step of polymerizing the polyamic acid, as the hydrocarbon-based solvent acts as a factor to hinder the polymerization. Therefore, a high molecular weight polyamic acid may not be obtained. On the other hand, in the composition for forming a polyimide film for a cover window according to an embodiment, after the polyamic acid and/or polyimide having a sufficient high molecular weight is obtained, the hydrocarbon-based solvent is mixed, and thus, may act as a catalyst to weaken the intermolecular interaction between the polymers and/or the strong interaction between the polymer and the solvent, and may impart excellent optical physical properties during later curing.

Composition for Forming Polyimide Film for Cover Window

In an embodiment, a composition for forming a polyimide film for a cover window may include: polyamic acid or polyimide including a structural unit derived from a dianhydride and a structural unit derived from diamine; and a mixed solvent of an amide-based solvent and a hydrocarbon-based solvent, in which the structural unit derived from the dianhydride may include a structural unit derived from a compound represented by Chemical Formula 1 below, and include a structural unit derived from a compound represented by Chemical Formula 2 below.

In addition, the composition for forming a polyimide film for a cover window according to an embodiment may satisfy Relational Expression 1 below. Although not limited to a particular theory, the composition for forming a polyimide film for a cover window that satisfies these conditions may improve optical physical properties by inhibiting the packing density of the polyimide film during the curing and making the polyimide film amorphous.

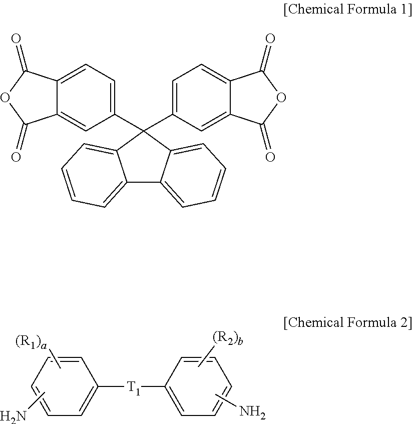

5,000≤V_{PI}≤20,000 [Relational Expression 1]

[in the Chemical Formula 2 above,

R₁ and R₂ may be each independently (C1-C10) alkyl, halo(C1-C10) alkyl, (C6-C12) aryl, halogen, hydroxy, (C1-C10) alkoxy, cyano, thiol, (C1-C10) mercapto, or nitro;

T₁ is selected from the group consisting of a single bond, (C1-C10) alkylene, (C6-C12) arylene, —O—, —C(═O)—, —C(═O)O—, C(═O)NH—, —S—, —SO₂—, and combinations thereof;

a and b are each independently an integer from 0 to 3;

in the Relational Expression 1 above,

V_{PI} is a viscosity of the composition for forming a polyimide film for a cover window when a solid content is 15 wt % based on a total weight of the composition for forming a polyimide film for a cover window, and the viscosity is a viscosity (unit, cp) measured with a Brookfield rotational viscometer using a 52Z spindle at 25° C. based on a torque of 80% for 2 minutes.]

In an embodiment, R₁ and R₂ may be the same as or different from each other. In an embodiment, R₁ and R₂ may each independently be halo (C1-C6) alkyl.

Specifically, R₁ and R₂ may be fluoro (C1-C6) alkyl in terms of providing a film having higher transmittance and lower haze. For example, R₁ and R₂ may be fluoromethyl, trifluoromethyl or perfluoroethyl, for example, trifluoromethyl.

In an embodiment, T₁ may be (C6-C12) arylene, for example, phenylene, biphenylene, or naphthalene, and specifically, phenylene. Accordingly, mechanical physical properties of a polyimide film may be more excellent.

In an embodiment, a and b may each independently be an integer of 1 to 3, for example, an integer of 1 or 2.

In an embodiment, when a is an integer of 2 or more, a plurality of R₁ may be the same as or different from each other, and when b is an integer of 2 or more, a plurality of R₂ may be the same as or different from each other.

A viscosity V_{PI} of the composition for forming a polyimide film for a cover window according to an embodiment may be 20,000 cp or less, or 10,000 cp or less, or 5,000 to 8,000 cp.

By having the above-described structural features, it is possible to provide a polyimide film for a cover window excellent in colorless and transparent performance, optical physical properties, and mechanical physical properties. Specifically, the polyimide film for a cover window according to an embodiment is colorless and transparent and has a remarkably improved retardation, and as a result, it is possible to effectively suppress a mura phenomenon and a rainbow phenomenon, and at the same time, realize excellent mechanical physical properties and heat resistance. Accordingly, the polyimide film prepared from the composition for forming a polyimide film for a cover window according to an embodiment may be applied to a new substrate material or a cover window material applicable to a foldable or flexible display device, and the polyimide film is more excellent visibility, thereby minimizing a user's eye fatigue.

More specifically, the composition for forming a polyimide film for a cover window according to an embodiment may be a composition in which the hydrocarbon-based solvent and the mixed solvent are mixed in a polyamic acid solution to satisfy the Relational Expression 1 above that includes the polyamic acid including the structural unit derived from the dianhydride represented by Chemical Formula 1 and the diamine represented by Chemical Formula 2 and an amide-based solution.

Here, by sequentially using the amide-based solvent and the hydrocarbon-based solvent, it is possible to adjust the interaction between the polyamic acid, which is a polyimide precursor, and the solvent to a more appropriate range. Here, the adjustment may mean inhibition.

Diamine and Dianhydride

In the composition for forming a polyimide film for a cover window according to an embodiment, the diamine represented by Chemical Formula 2 may be, for example, represented by Chemical Formula 3 below.

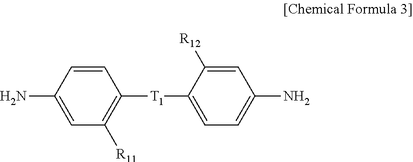

[in the Chemical Formula 3 above,

R₁₁ and R₁₂ are each independently hydrogen or halo (C1-C10) alkyl;

T₁ is a single bond, —O—, or

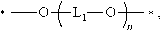

in which n is an integer of 1 to 3;

L₁ is (C1-C10) alkylene or (C6-C12) arylene.]

In an embodiment, R₁₁ and R₁₂ may be the same as each other.

In an embodiment, R₁₁ and R₁₂ may each independently be halo (C1-C6) alkyl.

Specifically, R₁₁ and R₁₂ may be fluoro (C1-C6) alkyl in terms of providing a film having higher transmittance and lower haze. For example, R₁₁ and R₁₂ may be fluoromethyl, trifluoromethyl or perfluoroethyl, for example, trifluoromethyl.

In an embodiment, L₁ may be (C6-C12) arylene, for example, phenylene, biphenylene, or naphthalene, and specifically, phenylene. Accordingly, the mechanical physical properties of the polyimide film for a cover window later may be more excellent.

The diamine represented by Chemical Formula 2 may be, for example, represented by the following Chemical Formulas 3-1 to 3-3, but is not limited thereto.

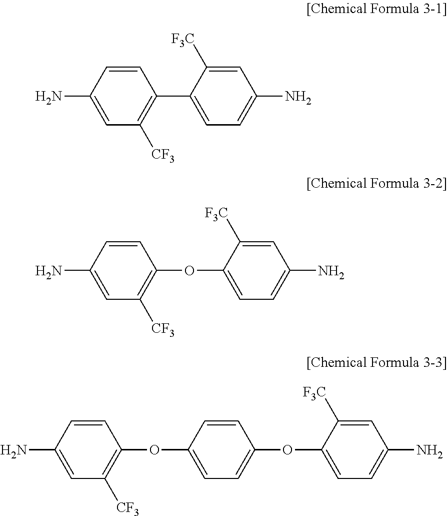 [SMILES: Nc1ccc(-c2ccc(N)cc2C(F)(F)F)c(C(F)(F)F)c1 ; Nc1ccc(Oc2ccc(N)cc2C(F)(F)F)c(C(F)(F)F)c1 ; Nc1ccc(Oc2ccc(Oc3ccc(N)cc3C(F)(F)F)cc2)c(C(F)(F)F)c1]

In an embodiment, examples of the diamine may include PDA (p-phenylenediamine), m-PDA (m-phenylenediamine), 4,4′-ODA (4,4′-oxydianiline), 3,4′-ODA (3,4′-oxydianiline), BAPP (2,2-bis(4-[4-aminophenoxy]-phenyl)propane), TPE-Q (1,4-bis(4)-aminophenoxy)benzene), TPE-R (1,3-bis(4-aminophenoxy)benzene), BAPB (4,4′-bis(4-aminophenoxy)biphenyl), BAPS (2, 2-bis(4-[4-aminophenoxy]phenyl)sulfone), m-BAPS (2,2-bis(4-[3-aminophenoxy]phenyl)sulfone), HAB (3,3′-dihydroxy-4,4′-diaminobiphenyl), TB (3,3-dimethylbenzidine), m-TB (2,2-dimethylbenzidine), TFMB (2,2-bistrifluoromethylbenzidine), 6FAPB (1,4-bis(4-amino-2-trifluoromethylphenoxy)benzene), 6FODA (2,2′-bis(trifluoromethyl)-4,4′-diaminodiphenylether), APB (1,3-bis (3-aminophenoxy)benzene), 1,4-ND (1,4-naphthalenediamine), 1,5-ND (1,5-naphthalenediamine), DABA (4,4′-diaminobenzanilide), 6-amino-2-(4-aminophenyl)benzoxazole, 5-amino-2-(4-aminophenyl)benzoxazole, or combinations thereof.

The composition for forming a polyimide film for a cover window according to an embodiment may include the structural unit derived from the dianhydride represented by Chemical Formula 1, thereby providing a film having more improved mechanical strength. In addition, it is possible to effectively inhibit the interaction between the polyamic acid prepared therefrom and the solvent to remarkably lower the intermolecular packing density during the curing, thereby providing excellent advantages in desired optical physical properties.

In addition, the dianhydride may be optionally used in combination with one or two or more selected from PMDA (pyromellitic dianhydride), BPDA (3,3′,4,4′-biphenyltetracarboxylic dianhydride), BTDA (3,3′,4,4′-benzophenonetetracarboxylic dianhydride), ODPA (4,4′-oxydiphthalic anhydride), BPADA (4,4′-(4,4′-isopropylbiphenoxy)biphthalic anhydride), DSDA (3,3′,4,4′-diphenylsulfonetetracarboxylic dianhydride), 6FDA (2,2′-bis-(3,4-dicarboxylphenyl) hexafluoropropane dianhydride), TMHQ (p-phenylene bistrimelic monoester anhydride), ESDA (2,2′-bis(4-hydroxyphenyl)propanedibenzoate-3,3′,4,4′-tetracarboxylicdianhydride), and NTDA (naphthalene tetracarboxylic dianhydride), and the like, but is not limited thereto.

Solvent

In the composition for forming a polyimide film for a cover window according to an embodiment, the amide-based solvent refers to a compound including an amide moiety. The amide-based solvent may be a cyclic compound or a chain compound, and specifically, a chain compound. For example, the amide-based solvent may have 2 to 15 carbon atoms, and may have, for example, 3 to 10 carbon atoms.

The amide-based solvent may include an N,N-dialkylamide moiety, and the dialkyl groups are each independently present and fused with each other to form a ring, or at least one alkyl group of the dialkyl groups may be fused with other substitutents in molecules to form a ring, and for example, at least one alkyl group of the dialkyl group may be fused with an alkyl group connected to carbonyl carbon of the amide moiety to form a ring. Here, the ring may be tetragonal to heptagonal rings, for example, pentagonal to heptagonal rings, for example, a pentagonal or hexagonal ring. The alkyl group may be, for example, a C1 to C10 alkyl group, for example, a C1 to C8 alkyl group, for example, methyl or ethyl, and the like.

More specifically, the amide-based solvent is not limited as long as it is generally used for polymerization of polyamic acid, but may be, for example, dimethylpropionamide, diethylpropionamide, dimethylacetylamide, diethylacetamide, dimethylformamide, methylpyrrolidone, ethylpyrrolidone, octylpyrrolidone, or a combination thereof, and specifically may include dimethylpropionamide.

In the composition for forming a polyimide film for a cover window according to an embodiment, the hydrocarbon-based solvent may be a non-polar molecule as described above.

The hydrocarbon solvent may be a compound consisting of carbon and hydrogen. For example, the hydrocarbon-based solvent may be aromatic or aliphatic, and for example, may be a cyclic compound or a chain compound, but specifically, may be a cyclic compound. Here, when the hydrocarbon solvent is a cyclic compound, the hydrocarbon solvent may include a single ring or a polycyclic ring, and the polycyclic ring may be a condensed ring or a non-condensed ring, but specifically may be a single ring.

The hydrocarbon-based solvent may have 3 to 15 carbon atoms, for example, 6 to 15 carbon atoms, for example, 6 to 12 carbon atoms.

The hydrocarbon-based solvent may be a substituted or unsubstituted C3 to C15 cycloalkane, a substituted or unsubstituted C6 to C15 aromatic compound, or a combination thereof. Here, the cycloalkane may be cyclobutane, cyclopentane, cyclohexane, cycloheptane, cyclooctane, or a combination thereof, and the aromatic compound may be benzene, naphthalene, or a combination thereof.

The hydrocarbon-based solvent may be a cycloalkane substituted or unsubstituted with at least one C1 to C5 alkyl group, an aromatic compound substituted or unsubstituted with at least one C1 to C5 alkyl group, or a combination thereof, in which the cycloalkane and aromatic compounds each are as described above.

The C1 to C5 alkyl group may be, for example, a C1 to C3 alkyl group, for example, a C1 or C2 alkyl group, and more specifically, a methyl group, but is not limited thereto.

In addition, the hydrocarbon-based solvent may further include oxygen, if necessary. For example, when the hydrocarbon-based solvent includes oxygen, the hydrocarbon-based solvent may include a ketone group or a hydroxyl group, for example, cyclopentanone, cresol, or a combination thereof.

Specifically, the hydrocarbon-based solvent may be benzene, toluene, cyclohexane, cyclopentanone, cresol, or a combination thereof, but is not limited thereto.

More specifically, the composition for forming a polyimide film for a cover window according to an embodiment may include a mixed solvent that includes an amide-based solvent including dimethylpropionamide and a hydrocarbon-based solvent selected from toluene, benzene, cyclohexane, and the like.

The hydrocarbon-based solvent according to an embodiment may be added after the polymerization of the polyamic acid or polyimide.

Accordingly, the composition for forming a polyimide film for a cover window according to an embodiment may exhibit intermolecular behavior and interaction different than simply adding a mixed solution in a step of polymerizing polyamic acid. For example, when the hydrocarbon-based solvent is included in the step of polymerizing the polyamic acid, as the hydrocarbon-based solvent acts as a factor to hinder the polymerization. Therefore, a high molecular weight polyamic acid may not be obtained. On the other hand, in the composition for forming a polyimide film for a cover window according to an embodiment, after obtaining the polyamic acid and/or polyimide having a sufficiently high molecular weight, the hydrocarbon-based solvent is mixed, such that the hydrocarbon-based solvent may act as a catalyst to weaken the intermolecular interaction between the polymers and/or the strong interaction between the polymer and the solvent, and desired optical properties may be obtained in subsequent curing.

In the composition for forming a polyimide film for a cover window according to an embodiment, the amide-based solvent and the hydrocarbon-based solvent may be included in a weight ratio of 8:2 to 5:5 in terms of realizing more improved retardation and yellow index, and specifically, may be included in a weight ratio of 8:2 to 6:4. In the above numerical range, the reactivity of diamine and dianhydride may be maintained excellently, and the intermolecular packing density is appropriately inhibited and amorphous during the curing of the composition for forming a polyimide film for a cover window. Accordingly, it is possible to provide a polyimide film for a cover window in which the retardation is remarkably improved without reducing mechanical physical properties, heat resistance, and transmittance.

Polyamic Acid and/or Polyimide

The composition for forming a polyimide film for a cover window according to an embodiment includes polyamic acid and/or polyimide including structural units derived from diamine and dianhydride exemplified above.

A weight average molecular weight (Mw) of the polyamic acid and/or polyimide is not particularly limited, but may be 10,000 g/mol or more, for example, 20,000 g/mol or more, for example, 25,000 to 80,000 g/mol. In addition, the glass transition temperature is not limited, but may be 100 to 400° C., more specifically 100 to 380° C. In the above range, it is preferable to provide a film having more excellent optical physical properties, more excellent mechanical strength, and less curling, but is not necessarily limited thereto.

The solid content of the composition for forming a polyimide film for a cover window according to an embodiment may be in a range of 40 wt % or less, or 35 wt % or less, or 10 to 20 wt % based on the total weight of the composition for forming a polyimide film for a cover window. Here, the solid content may be the polyamic acid and/or polyimide.

When the polyamic acid and/or polyimide is dissolved in the typical amide-based solvent alone, the viscosity of the solution may be in the range of 20,000 cps or more, or 25,000 cps or more, or 35,000 cps or less. Here, the viscosity of the solution means the viscosity when the solid content is 15 wt % based on the total weight of the solution.

On the other hand, the composition for forming a polyimide film for a cover window according to an embodiment may use the mixed solvent of the amide-based solvent and the hydrocarbon-based solvent to remarkably lower the viscosity of the composition, even if it contains a high solid content of 15 wt %, and thus, may be applied to a thin film coating process with a high solid content and a low viscosity. In general, in the case of the polyimide, the higher the concentration of the solid content, the higher the viscosity tends to be. However, when the polymer flow is not good in the thin film coating process, bubbles are generated and mura occurs in the coating. However, when an embodiment is applied, such a thin film coating process defect may be effectively prevented, so more improved optical physical properties may be realized. In addition, as described above, when dissolved in the amide-based solvent alone, it is difficult to increase the concentration of the solid content due to the high viscosity, thereby reducing the process efficiency. According to an embodiment, it may be used as the composition for forming a polyimide film for a cover window having a high solid content without causing such a problem, and thus may be commercially advantageous.

Method for Preparing Composition for Forming Polyimide Film for Cover Window

A method for preparing a composition for forming a polyimide film for a cover window according to an embodiment may include: i) preparing a polyamic acid solution by reacting dianhydride represented by the Chemical Formula 1 above and diamine represented by the Chemical Formula 2 above in an amide-based solvent; and ii) adjusting a viscosity by additionally adding a hydrocarbon-based solvent to satisfy the Relational Expression 1 above;

Specifically, step i) is polymerizing polyamic acid by mixing diamine and dianhydride in an equivalent ratio of 1:0.9 to 1:1.1, and may include dissolving the diamine in an amide-based solvent at a temperature of 20 to 30° C.; adding dianhydride to a solution at a temperature of 40 to 60° C. to dissolve the dianhydride; and stirring the reaction solution for 5 to 7 hours to react.

In the reaction solution of step i) according to an embodiment, the solid content may be included in an amount of 15 to 25 wt %, and may be included in an amount of 17 to 23 wt %, based on the total weight of the reaction solution. In the above numerical range, it is possible to obtain a polyamic acid having a desired weight average molecular weight while keeping polymerization reaction of the diamine and dianhydride excellent.

In step ii) according to an embodiment, the above-described hydrocarbon solvent is additionally added and stirred, and then the mixed solvent of the amide-based solvent and the hydrocarbon-based solvent may be additionally added so that the viscosity range of the composition for forming a polyimide film for a cover window may satisfy the Relational Expression 1 above.

Specifically, step ii) includes additionally adding 25 to 50 parts by weight of the hydrocarbon-based solvent based on 100 parts by weight of the amide-based solvent of step i) at room temperature (25° C.) and stirring for 15 to 20 hours; and adding the mixed solvent of the amide-based solvent and the hydrocarbon-based solvent to satisfy the Relational Expression 1 above after the stirring. Although not limited to a particular theory, the composition for forming a polyimide film for a cover window that satisfies these conditions may inhibit the packing density of the polyimide film during the curing and make the polyimide film amorphous. Accordingly, it is possible to provide the polyimide film for a cover window in which the retardation is remarkably improved without reducing mechanical physical properties, heat resistance, and transmittance.

In addition, the composition for forming a polyimide film for a cover window according to an embodiment may exhibit the intermolecular behavior and interaction different than simply adding the mixed solution in the polymerization step of the polyamic acid. For example, when the hydrocarbon-based solvent is included in the step of polymerizing the polyamic acid, as the hydrocarbon-based solvent acts as a factor to hinder the polymerization. Therefore, a high molecular weight polyamic acid may not be obtained.

On the other hand, in the composition for forming a polyimide film for a cover window according to an embodiment, after the polyamic acid and/or polyimide having a sufficient high molecular weight is obtained, the hydrocarbon-based solvent may be mixed to obtain the polyamic acid having a high molecular weight, and the hydrocarbon-based solvent may act as a catalyst to weaken the intermolecular interaction between the polymers and/or the strong interaction between the polymer and the solvent, and may obtain a desired optical physical properties during later curing.

Molded Body

The molded body according to an embodiment may be a molded body manufactured using the above-described composition for forming a polyimide film for a cover window.

A first aspect of the molded body according to an embodiment may be the polyimide film for a cover window.

In addition, a second aspect of the molded body according to an embodiment may be a multilayer structure including the polyimide film.

In addition, a third aspect of the molded body according to an embodiment may be a cover window for a display device including the polyimide film.

In addition, a fourth aspect of the molded body according to an embodiment may be a flexible display panel including the polyimide film.

The polyimide film for a cover window according to an embodiment may have a thickness of 20 to 500 μm, for example, 30 to 300 μm, for example, 50 to 100 μm. Further, an absolute value of a retardation Rth in a thickness direction at a wavelength of 550 nm may be 100 to 300 nm, for example, 100 to 280 nm, for example, 120 to 280 nm, for example, 120 to 220 nm, for example, 120 to 200 nm.

In the above numerical range, the polyimide film for a cover window according to an embodiment has the remarkably improved retardation, so it is possible to more effectively suppress the mura phenomenon and the rainbow phenomenon, which are the problems of visibility when used as the cover window of the display panel.

The polyimide film for a cover window according to an embodiment may have a yellow index (YI) of 4 or less, or 3.5 or less, or 3 or less according to ASTM E131.

Within the above numerical range, the polyimide film for a cover window according to an embodiment may satisfy excellent optical physical properties such as transmittance and remarkably reduce distortion caused by light.

Method for Preparing Polyimide Film for Cover Window

In addition, according to an embodiment, a method for preparing a polyimide film for a cover window may include: i) applying the composition for forming a polyimide film for a cover window to a substrate; and curing the composition for forming a polyimide film for a cover window by drying and heating.

Specifically, step i) is applying the composition for forming a polyimide film for a cover window to a substrate such as glass, and the applying method may be used without being limited as long as it is commonly used in the relevant field. Non-limiting examples thereof may include knife coating, dip coating, roll coating, slot die coating, lip die coating, and slide coating, and curtain coating, and the like, and the like. In this regard, it goes without saying that the same type or different types can be sequentially applied one or more times.

In addition, the substrate may be used without limitation as long as it is conventionally used in the field, and non-limiting examples thereof may include glass; stainless; or plastic films such as polyethylene terephthalate, polyethylene naphthalate, polypropylene, polyethylene, cellulose triacetate, cellulose diacetate, poly(meth)acrylic acid alkyl ester, a poly(meth)acrylic acid ester copolymer, polyvinyl chloride, polyvinyl alcohol, polycarbonate, polystyrene, cellophane, a polyvinylidene chloride copolymer, polyamide, polyimide, vinyl chloride/vinyl acetate copolymer, polytetrafluoroethylene, and polytrifluoroethylene, but are not limited thereto. In addition, the polyimide film for a cover window according to an embodiment may have an adhesive force of 5 gf/in or more, 10 gf/in or more, or 15 gf/in or more with a substrate such as glass. The polyimide film according to an embodiment has reduced intermolecular density, and thus screen distortion may not occur when the polyimide film is applied to a cover window of a flexible display. In step ii) according to an embodiment, the drying may be performed at 30 to 80° C., or 40 to 80° C., or 50 to 80° C.

The thermosetting may be performed at 80 to 400° C., or 90 to 380° C., or 100 to 350° C.

More specifically, the thermosetting may be performed at 80 to 100° C. for 1 minute to 2 hours, at exceeding 100 to 200° C. for 1 minute to 2 hours, or at more than 200 to 350° C. for 1 minute to 2 hours. Stepwise thermal curing may be performed under two or more temperature conditions selected from these. In addition, the thermosetting may be performed in a separate vacuum oven, an oven filled with an inert gas, or the like, but is not necessarily limited thereto.

The curing step may also be performed through chemical curing.

The chemical curing may be performed using an imidization catalyst, and non-limiting examples of the imidization catalyst may include any one or two selected from pyridine, isoquinoline, and β-quinoline, and the like, but is not necessarily limited thereto.

In the method for preparing a polyimide film for a cover window according to an embodiment, if necessary, the method may further include applying the composition for forming a polyimide film for a cover window to a substrate and then leaving the composition at room temperature.

Through the leaving step, the optical physical properties of the film surface may be more stably maintained. Although not limited to a particular theory, in the conventional composition for forming a polyimide film, when the leaving step is performed before the curing, the solvent absorbs moisture in the air, the moisture diffuses inside, and collides with polyamic acid and/or polyimide, and thus, cloudiness may occur from the surface of the film, and agglomeration may occur, resulting in coating non-uniformity. On the other hand, the composition for forming a polyimide film for a cover window according to an embodiment does not have the cloudiness or agglomeration phenomenon even if the composition is left in air for a long time, and thus, it is possible to realize the advantage of securing a film having improved optical physical properties.

The leaving step may be performed at room temperature and/or high humidity conditions. Here, the room temperature may be 40° C. or less, for example, 30° C. or less, for example, 25° C. or less, more specifically 15 to 25° C., and 20 to 25° C. In addition, the high humidity may be a relative humidity of, for example, 50% or more, for example, 60% or more, for example, 70% or more, for example, 80% or more.

The leaving step may be performed for 1 minute to 3 hours, for example, 10 minutes to 2 hours, for example, 20 minutes to 1 hour.

In the method for preparing a polyimide film for a cover window according to an embodiment, one or more additives selected from a flame retardant, an adhesion enhancer, inorganic particles, antioxidant, UV inhibitor, plasticizer, and the like are mixed in the polyamic acid solution, thereby preparing the polyimide film for a cover window.

In addition, the multilayer structure according to an embodiment may include the polyimide film for a cover window of an embodiment formed on the substrate. If necessary, the multilayer structure may further include a functional coating layer on at least one other surface of the polyimide film or the substrate. Non-limiting examples of the functional coating layer may include a hard coating layer, an antistatic layer, an anti-fingerprint layer, an antifouling layer, an anti-scratch layer, a low refractive layer, an antireflection layer, an impact absorption layer, and the like, and at least one or two or more functional coating layers may be provided.

The molded body according to an embodiment may include the polyimide film of the embodiment on one surface of the substrate to prevent scattering, and may include a hard coating layer provided on at least one other surface of the substrate.

In addition, specific examples of the molded body manufactured using the composition for forming a polyimide film for a cover window according to an embodiment include a cover window for a display device, a printed wiring board including a protective film or an insulating film, a flexible circuit board, and the like, and is not limited thereto. In addition, the polyimide film may be applied to a protective film that can replace tempered glass, and has the advantage of a wide range of applications in various industrial fields, including displays, due to improved optical physical properties.

Due to excellent optical physical properties such as remarkably improved retardation and low yellow index, the polyimide film may be specifically used as a cover window of a flexible display panel or the like. The cover window including the polyimide film for the cover window according to an embodiment not only has superior optical physical properties, but also exhibits sufficient retardation at various angles to secure a wide viewing angle.

In addition, specific examples of the molded body manufactured using the composition for forming a polyimide film for a cover window according to an embodiment may include, but is not limited to, a flexible display panel or a flexible display device including the above-described cover window. In this case, the cover window may be used as an outermost window substrate of the flexible display device. The flexible display device may be various image display devices such as the conventional liquid crystal display device, an electroluminescence display device, a plasma display device, and a field emission display device.

Hereinafter, an embodiment will be given for a detailed description of an embodiment, but the present invention is not limited to the following Examples.

In the following experiment, the physical properties were measured as follows.

<Viscosity (V_{PI})>

The viscosity value was measured with a plate rheometer (model name: LVDV-1II Ultra, manufactured by Brookfield) when there is no torque change after waiting for 2 minutes when the torque reaches 80% by putting 0.5 μl of the composition for forming a polyimide film for a cover window (concentration of solid content: 15 wt %) in a container, lowering the spindle, and adjusting rpm. In this case, the viscosity was measured at 25° C. using a 52Z spindle. The unit is cp.

<Retardation (Rth)>

The measurement was made using Axoscan. The film was cut to a certain size to measure the thickness, and then the thickness (nm) measured while correcting in the C-plate direction was inputted in order to compensate for the retardation value by measuring the retardation with Axoscan.

<Yellow index (YI)>

The yellow index was measured using a spectrophotometer (COH-5500 from Nippon Denshoku Co.) based on ASTM E313 standard, and the measurement results were evaluated according to the following criteria.

O: Yellow index of 4 or less, X: Yellow index of 4 or more

<Weight Average Molecular Weight>

The weight average molecular weight was measured by dissolving the film in DMAc eluent containing 0.05M LiCl. For GPC, waters GPC system, waters 1515 isocratic HPLC Pump, and Waters 2414 Refractive Index detector were used, and the column was connected to Olexis, Polypore and mixed D columns, and polymethyl methacrylate (PMMA STD) was used as a standard material, and analysis was performed at 35° C. and a flow rate of 1 mL/min.

### Example 1

Preparation of Composition for Forming Polyimide Film for Cover Window (TFMB/BPAF)

After filling 173 g of DMPA (N,N-dimethylpropionamide) in a stirrer through which a nitrogen stream flows, 20.74 g of TFMB (2,2-bistrifluoromethylbenzidine) was dissolved while the temperature of the reactor was maintained at 25° C. Here, 30 g of BPAF (9,9-bis (3,4-dicarboxyphenyl) fluorene dianhydride) was added at 50° C. and stirred while being dissolved. After stirred for 6 hours, 74.3 g of toluene was added at 25° C., and the mixture was stirred for 18 hours. Then, a mixed solvent of DMPA:toluene=70 wt %:30 wt % was added so that the solid content was 15 wt % based on the total weight of the composition, thereby preparing composition 1 for forming a polyimide film for a cover window.

Preparation of Polyimide Film for Cover Window

The composition 1 for forming a polyimide film for a cover window 1 obtained above was applied to one surface of a glass surface (1.0 T) with #20 meyer bar, cured by heating at 80° C. for 30 minutes under a nitrogen stream, and then at 350° C. for 15 minutes, and peeled off from the glass substrate, thereby obtaining the polyimide film for a cover window of Example 1 having a thickness of 50 μm.

### Example 2

Preparation of Composition (6FODA/BPAF) for Forming Polyimide Film for Cover Window

After filling 177 g of DMPA in a stirrer through which a nitrogen stream flows, 21.7 g of 6FODA (2,2′-bis(trifluoromethyl)-4,4′-diaminodiphenyl ether) was dissolved while maintaining the temperature of the reactor at 25° C. Here, 30 g of BPAF was added at a temperature of 50° C. and stirred while being dissolved. After stirred for 6 hours, 75.8 g of toluene was added at 25° C., and was stirred for 18 hours. Then, a mixed solvent of DMPA:toluene=70 wt %:30 wt % was added so that the solid content was 15 wt % based on the total weight of the composition, thereby preparing composition 2 for forming a polyimide film for a cover window.

Preparation of Polyimide Film for Cover Window

Using the obtained composition 2 for forming a polyimide film for a cover window, a polyimide film for a cover window of Example 2 having a thickness of 50 μm was obtained in the same manner as in Example 1.

### Example 3

Preparation of Composition (6FAPB/BPAF) for Forming Polyimide Film for Cover Window

After filling 197.4 g of DMPA in a stirrer through which a nitrogen stream flows, 27.7 g of 6FAPB (1,4-bis(4-amino-2-trifluoromethylphenoxy)benzene) was dissolved while maintaining the temperature of the reactor at 25° C. Here, 30 g of BPAF was added at a temperature of 50° C. and stirred while being dissolved. After stirred for 6 hours, 84.6 g of toluene was added at 25° C., and was stirred for 18 hours. Then, a mixed solvent of DMPA:toluene=70 wt %:30 wt % was added so that the solid content was wt % based on the total weight of the composition, thereby preparing composition 3 for forming a polyimide film for a cover window.

Preparation of Polyimide Film for Cover Window

Using the obtained composition 3 for forming a polyimide film for a cover window, a polyimide film for a cover window of Example 3 having a thickness of 50 μm was obtained in the same manner as in Example 1.

### Examples 4 and 5

Preparation of Composition (6FAPB/BPAF) for Forming Polyimide Film for Cover Window

Compositions 4 and 5 for forming a polyimide film for a cover window were prepared in the same manner as in Example 3, except that DMPA and/or toluene were added so that a toluene content satisfies a T content of Table 1 below, based on the total weight of DMPA and toluene in the composition for forming a polyimide film for a cover window.

Preparation of Polyimide Film for Cover Window

Using the obtained compositions 4 and 5 for forming a polyimide film for a cover window, the polyimide film for a cover window of Examples 4 and 5 having a thickness of 50 μm was obtained in the same manner as in Example 1.

### Comparative Example 1

Preparation of Composition for Forming Polyimide Film for Cover Window (TFMB/BPAF)

After filling 372 g of DMPA in a stirrer through which a nitrogen stream flows, 20.74 g of TFMB was dissolved while the temperature of the reactor was maintained at 25° C. Here, 30 g of BPAF was added at a temperature of 50° C. and stirred while being dissolved. After stirred for 24 hours, the DMPA was added so that the solid content was 15 wt % based on the total weight of the composition, thereby preparing composition A for forming a polyimide film for a cover window.

Preparation of Polyimide Film for Cover Window

Using the obtained composition A for forming a polyimide film for a cover window, a polyimide film for a cover window of Comparative Example 1 having a thickness of 50 μm was obtained in the same manner as in Example 1.

### Comparative Example 2

Preparation of Composition (6FODA/BPAF) for Forming Polyimide Film for Cover Window

After filling 379 g of DMPA in a stirrer through which a nitrogen stream flows, 21.7 g of 6FODA was dissolved while the temperature of the reactor was maintained at 25° C. Here, 30 g of BPAF was added at a temperature of 50° C. and stirred while being dissolved. After stirred for 24 hours, the DMPA was added so that the solid content was 15 wt % based on the total weight of the composition, thereby preparing composition B for forming a polyimide film for a cover window.

Preparation of Polyimide Film for Cover Window

Using the obtained composition B for forming a polyimide film for a cover window, a polyimide film for a cover window of Comparative Example 2 having a thickness of 50 μm was obtained in the same manner as in Example 1.

### Comparative Example 3

Preparation of Composition (6FAPB/BPAF) for Forming Polyimide Film for Cover Window

After filling 296.4 g of DMPA in a stirrer through which a nitrogen stream flows, 27.7 g (0.06 mol) of 6FAPB was dissolved while the temperature of the reactor was maintained at 25° C. Here, 30 g (0.06 mol) of BPAF was added at a temperature of 50° C. and stirred while being dissolved. After stirred for 24 hours, the DMPA was added so that the solid content was 15 wt % based on the total weight of the composition, thereby preparing composition C for forming a polyimide film for a cover window.

Preparation of Polyimide Film for Cover Window

Using the obtained composition C for forming a polyimide film for a cover window, a polyimide film for a cover window of Comparative Example 3 having a thickness of 50 μm was obtained in the same manner as in Example 1.

### Comparative Examples 4 and 5

Preparation of Composition (6FAPB/BPAF) for Forming Polyimide Film for Cover Window

Compositions D and F for forming a polyimide film for a cover window were prepared in the same manner as in Example 3, except that DMPA and/or toluene were added so that a toluene content satisfies a T content of Table 2 below, based on the total weight of DMPA and toluene in the composition for forming a polyimide film for a cover window.

Preparation of Polyimide Film for Cover Window

Using the obtained composition for forming a polyimide film for a cover window, a polyimide film for a cover window of Comparative Examples 4 and 5 having a thickness of 50 μm was obtained in the same manner as in Example 1.

<Evaluation of Optical Properties of Polyimide Film>

The physical properties of a polyimide film for a cover window prepared in Examples 1 to 5 and Comparative Examples 1 to were measured, and are shown in Tables 1 and 2 below. The viscosity in Tables 1 and 2 below is the viscosity of the composition for forming a polyimide film for a cover window prepared in Examples 1 to 5 and Comparative Examples 1 to 5.

TABLE 1

| | Example | Example | Example | Example | Example |
|---|---|---|---|---|---|
| | 1 | 2 | 3 | 4 | 5 |
| T content | 30 | 30 | 30 | 25 | 45 |
| (wt %) | | | | | |
| Viscosity | 7,800 | 8,200 | 7,900 | 9,800 | 6,200 |
| (cp) | | | | | |
| Thickness | 50 | 50 | 50 | 50 | 50 |
| (μm) | | | | | |
| Rth | 240 | 175 | 160 | 180 | 165 |
| (500 nm) | | | | | |
| YI | 2.1 | 2.6 | 2.5 | 2.5 | 2.5 |
| | ∘ | ∘ | ∘ | ∘ | ∘ |

TABLE 2

| | Comparative | Comparative | Comparative | Comparative | Comparative |
|---|---|---|---|---|---|
| | Example 1 | Example 2 | Example 3 | Example 4 | Example 5 |
| T content | 0 | 0 | 0 | 10 | 60 |
| (wt %) | | | | | |
| Viscosity | 23,000 | 21,000 | 26,000 | 28,000 | 50,000 or |
| (cp) | | | | | more |
| Thickness | 50 | 50 | 50 | 50 | No |
| (μm) | | | | | polymerization |
| Rth | 310 | 284 | 205 | 300 | |
| (500 nm) | | | | | |
| YI | 2.3 | 2.6 | 2.5 | 2.5 | |
| | ∘ | ∘ | ∘ | ∘ | |

Referring to Table 1, it could be seen that the composition for forming a polyimide film for a cover window according to an embodiment has a viscosity of 5,000 to 20,000 cp and includes a mixed solvent of an amide-based solvent and a hydrocarbon-based solvent, thereby forming a film having a thickness sufficient to be used as a cover film of a flexible display.

On the other hand, in the composition for forming a polyimide film for a cover window prepared in Comparative Example 5, the initial polymerization solid content was high, and the solution viscosity became uncontrollably high, so the polymerization was impossible. In addition, the composition for forming a polyimide film for a cover window prepared in Comparative Example 4 had a high viscosity compared to solid content and no air bubbles were removed, resulting in disadvantages in the process, and making the coating surface non-uniform. Therefore, after curing, the surface of the coating layer was evaluated as poor because it was somewhat rough, and it could be seen that it is unsuitable for preparing the polyimide film. Furthermore, it was confirmed that the composition for forming a polyimide film for a cover window of Comparative Example 4 had a rough surface after coating, and thus, the retardation value remarkably increased.

On the other hand, it could be seen that the polyimide film prepared from the composition (Examples 1 to 5) for forming a polyimide film for a cover window according to an embodiment exhibits remarkably improved retardation and realizes better optical physical properties. In addition, it could be usefully applied as the cover window of the flexible display because it is flexible and has better bending characteristics while improving the distortion of the screen.

In addition, it could be seen that the polyimide film according to the embodiment has excellent scattering resistance because it shows excellent adhesion.

On the other hand, in the composition for forming a polyimide film for a cover window prepared in Comparative Examples 1 to 4, the packing density between molecules increased during thermal curing, and thus the retardation value of the polyimide film prepared therefrom increased. However, it could be seen that the films of Examples 1 to 5 has the remarkably improved retardation value while maintaining excellent yellow index value compared to the films of Comparative Examples 1 to 5.

Hereinabove, although one embodiment has been described by limited examples, these are only provided to help a more general understanding of the present invention. Therefore, the present invention is not limited to the embodiments. Various modifications and changes may be made by those skilled in the art to which the present invention pertains from this description.

Therefore, the spirit of the present invention should not be limited to these embodiments, but the claims and all of modifications equal or equivalent to the claims are intended to fall within the scope and spirit of the present invention.

1. A composition for forming a polyimide film for a cover window, comprising:
polyamic acid or polyimide comprising a structural unit derived from a dianhydride and a structural unit derived from diamine; and
a mixed solvent of an amide-based solvent and a hydrocarbon-based solvent,
wherein, in the composition for forming a polyimide film for a cover window satisfying Relational Expression 1 below,
the structural unit derived from the dianhydride comprises a structural unit derived from a compound represented by Chemical Formula 1 below, and the structural unit derived from the diamine comprises a structural unit derived from a compound represented by Chemical Formula 2 below. 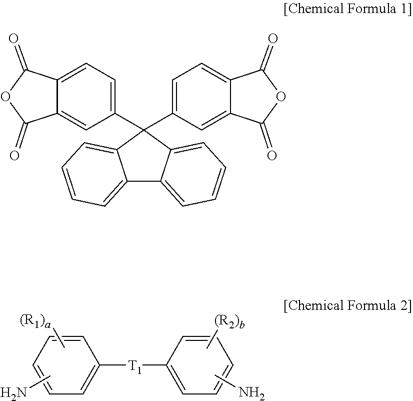
5,000≤V_{PI}≤20,000 [Relational Expression 1]
in the Chemical Formula 2 above,
R₁ and R₂ are each independently (C1-C10) alkyl, halo(C1-C10) alkyl, (C6-C12) aryl, halogen, hydroxy, (C1-C10) alkoxy, cyano, thiol, (C1-C10) mercapto, or nitro;
T₁ is selected from the group consisting of a single bond, (C1-C10) alkylene, (C6-C12) arylene, —O—, —C(═O)—, —C(═O)O—, C(═O)NH—, —S—, —SO₂—, and combinations thereof;
a and b are each independently an integer from 0 to 3;
in the Relational Expression 1 above,
V_{PI} is a viscosity of the composition for forming a polyimide film for a cover window when a solid content is 15 wt % based on a total weight of the composition for forming a polyimide film for a cover window, and the viscosity is a viscosity (unit, cp) measured with a Brookfield rotational viscometer using a 52Z spindle at 25° C. based on a torque of 80% for 2 minutes.

2. The composition of claim 1, wherein
the diamine represented by the Chemical Formula 2 above is represented by Chemical Formula 3 below: 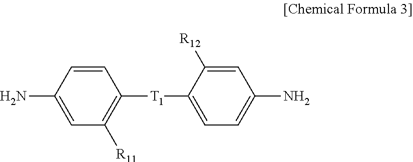
in the Chemical Formula 3 above,
R₁₁ and R₁₂ are each independently hydrogen or halo (C1-C10) alkyl,
T₁ is a single bond, —O—, or 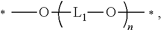
in which n is an integer of 1 to 3, and
L₁ is (C1-C10) alkylene or (C6-C12) arylene.

3. The composition of claim 1, wherein the amide-based solvent comprises dimethylpropionamide.

4. The composition of claim 1, wherein the hydrocarbon-based solvent is a cyclic hydrocarbon-based solvent.

5. The composition of claim 4, wherein the cyclic hydrocarbon-based solvent is toluene, benzene, cyclohexane, or a combination thereof.

6. The composition of claim 1, wherein the hydrocarbon-based solvent is added after polymerization of the polyamic acid or polyimide.

7. The composition of claim 1, wherein the solid content of the composition for forming a polyimide film for a cover window is included in amount of 10 to 40 wt % based on the total weight of the composition for forming a polyimide film.

8. The composition of claim 1, wherein the amide-based solvent and the hydrocarbon-based solvent in a weight ratio of 8:2 to 5:5.

9. A method for preparing a composition for forming a polyimide film for a cover window, the method comprising the steps of:
i) preparing a polyamic acid solution by reacting dianhydride represented by Chemical Formula 1 below and diamine represented by Chemical Formula 2 below in an amide-based solvent; and
ii) adjusting a viscosity by additionally adding a hydrocarbon-based solvent to satisfy Relational Expression 1 below, 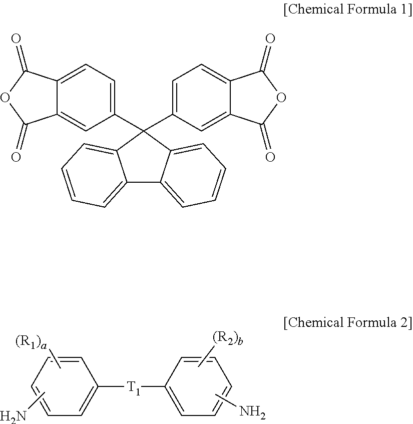
5,000≤V_{PI}≤20,000 [Relational Expression 1]
R₁, R₂, a, and b of the Chemical Formula 2 above are the same as defined in the Chemical Formula 2 above of claim 1, and the V_{PI} of the Relational Expression 1 above is the same as defined in the Relational Expression 1 above of claim 1.

10. The method for claim 9, wherein
step ii) includes:
additionally adding and stirring 25 to 50 parts by weight of the hydrocarbon-based solvent based on 100 parts by weight of the amide-based solvent of step i); and
additionally adding a mixed solvent of the amide-based solvent and the hydrocarbon-based solvent to satisfy the Relational Expression 1 above.

11. A polyimide film for a cover window obtained by curing the composition for forming a polyimide film for a cover window of claim 1.

12. The polyimide film of claim 11, wherein
the polyimide film for the cover window has a thickness of 20 to 500 μm, has an absolute value of retardation Rth of 100 to 300 nm in a thickness direction at a wavelength of 550 nm is 100 to 300 nm, and has a yellow index (YI) of 4 or less according to ASTM E131.

13. A method for preparing a polyimide film for a cover window, comprising the steps of:
applying the composition for forming a polyimide film for a cover window of claim 1 on a substrate; and
curing the composition for forming a polyimide film for a cover window by drying and heating.

14. The method of claim 13, wherein the curing is performed by drying at 30° C. to 70° C., and then heating at 100° C. to 400° C.

15. The method of claim 13, further comprising:
after the applying, leaving the composition at room temperature.

16. A multilayer structure comprising the polyimide film for a cover window of claim 11 provided on one surface of a substrate.

17. A cover window for a display device, comprising:
the polyimide film for a cover window of claim 11; and
a coating layer formed on the polyimide film.

18. The cover window of claim 17, wherein the coating layer is a hard coating layer, an antistatic layer, an anti-fingerprint layer, an antifouling layer, an anti-scratch layer, a low refractive layer, an antireflection layer, an impact absorption layer, or a combination thereof.
